(19) United States
(12) Patent Application Publication
(10) Pub. No.: US 2004/0231776 A1
(43) Pub. Date: Nov. 25, 2004

(54) Method and device for operating a system for monitoring and wirelessly wirelessly signalling a pressure change, and for automatically regulating the pressure in pneumatic tyres on vehicles

(76) Inventor: Gerhard Skoff, Vienna (AT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/485,321

(22) PCT Filed: May 3, 2002
(86) PCT No.: PCT/AT02/00136

(30) Foreign Application Priority Data
Aug. 14, 2001 (AT) A 1274/01

(51) Int. Cl. B60C 23/10

(52) U.S. Cl. 152/416; 137/224; 340/442

(57) ABSTRACT

The invention relates to a method for operating a system for monitoring and wirelessly signalling a pressure change, and for automatically regulating the pressure in pneumatic tyres on vehicles. The invention is characterised in that an electronic sensor mechanism (12) inside the tyre provides pressure information for the electronic tyre pressure regulation system. This enables both an increase in the reliability and the safety of the wheel system and an improvement in the driving dynamics.

The invention relates to a method for operating a device for monitoring and wirelessly signalling a pressure change, and for automatically regulating the pressure in pneumatic tyres on vehicles according to the preamble of claim 1.

The correct tyre pressure is an important requirement for using the full driving dynamic properties of a tyre and for achieving its structurally predetermined lifetime and reliability. If one tyre pressure is too high or too low, this leads to rapid wear of the vehicle tyre on one side. Too low a tyre pressure and the high flexing energy resulting therefrom imposes a very severe thermal loading on the tyre and can result in irreparable damage to the carcass of the tyre. In addition to mechanical damage, this is the most common cause of the failure of modern vehicle tyres.

Meanwhile, it has become state of the art, especially in top-of-the-range vehicles, to equip vehicles with a tyre pressure control system. A typical application for this purpose is known from WO 98/05519. In this case, the respective wheel is fitted with a wheel electronic system which contains a pressure sensor, a circuit for processing the pressure measurement signal, a transmitter with a transmitting antenna and a battery. The wheel electronic systems of the individual wheels transmit their signals at regular intervals to the central control unit. The energy required to operate the sensors and the electronic system and for transmitting the signals is taken from a battery which is built into the electronic control system and for which the longest possible operating time in the automobile, generally seven to ten years, is strived for. However, since this wheel electronic system is usually accommodated in the air space in the tyre, preferably constructed as a continuation of the valve, the entire electronic unit including the battery is usually hermetically enclosed or even surrounded with a sealing compound for reasons of operating safety. As a result of it being built in, the overall size and thus the capacity of the battery is very limited. In order to achieve the required long lifetime, it should be ensured that the current consumption of the entire unit is as low as possible since changing the battery would involve considerable effort and considerable costs.

In DE 199 61020 A1 it is proposed that the air pressure in the tyres should be checked every time the vehicle is started and regulated if necessary.

However, an analysis of the load-tyre air pressure performance graph clearly shows that even a small change in the axle load, such as occurs, for example, in the course of a fairly long route as a result of the fuel consumption or as a result of a passenger getting in or getting out, causes a change in the desired air pressure. This finding should be taken into account within the framework of the invention by the fact that during the journey the axle loads are determined in time steps for a certain time with the engine running and when the wheels are simultaneously at a standstill, and the last value of the axle load is used as the current actual value to calculate the desired value of the tyre pressure. This ensures continuous monitoring of the loading state.

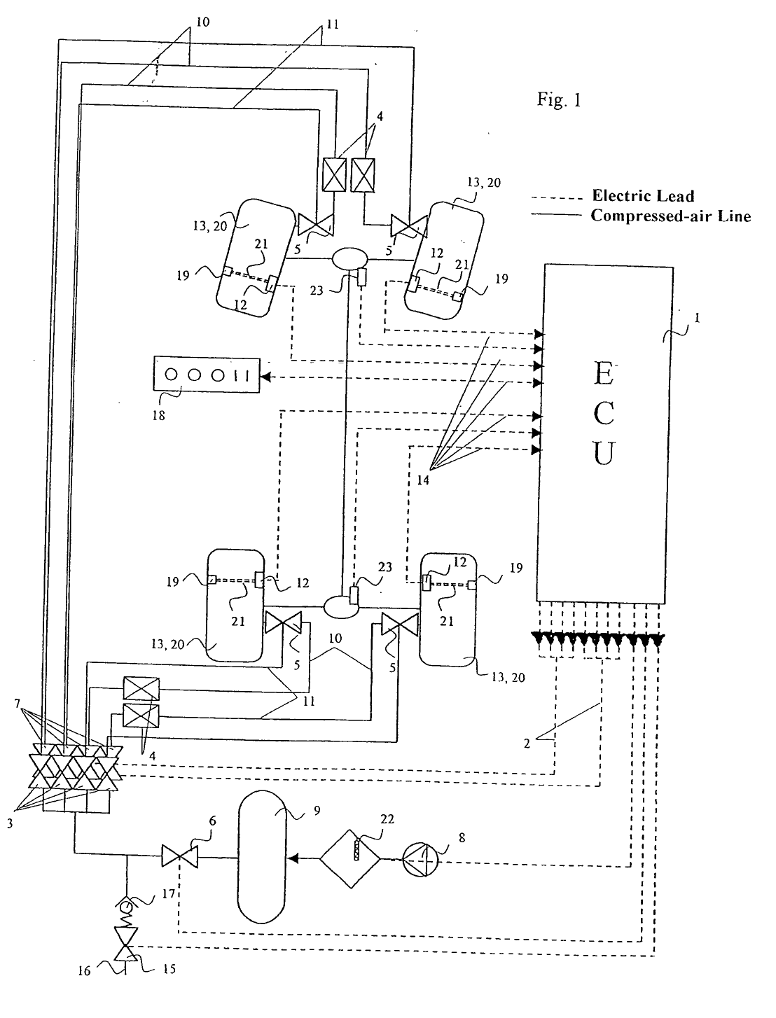

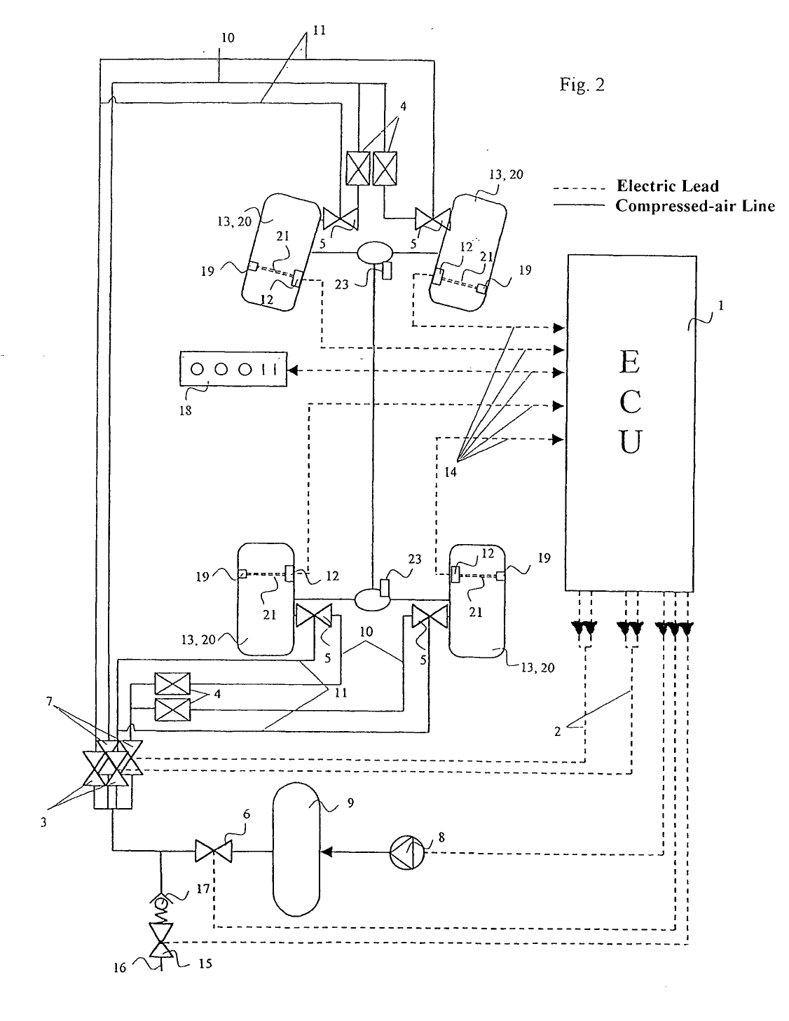

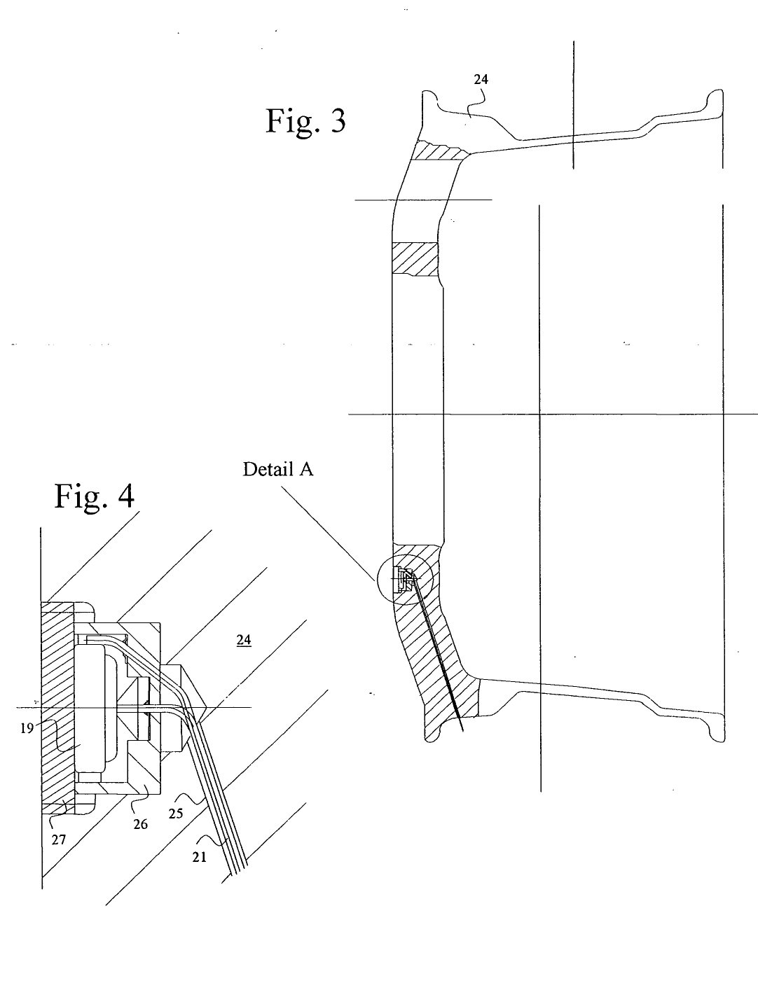

The invention is explained in detail subsequently with reference to exemplary embodiments shown in the drawings without being restricted to these examples. In this case, FIG. 1 shows a circuit diagram for the control of each individual wheel, and FIG. 2 shows a possible simplification of the system by combining several wheels into a control circuit. FIG. 3 shows a section through a wheel rim and FIG. 4 shows the detail A with the second battery on an enlarged scale compared with FIG. 3.

In accordance with FIG. 1, the control is provided by a central electronic control unit 1. This electronic unit 1 is linked to a sensor system which, among other things, monitors the loading state, the tyre pressure, the driving speed and the driving state and communicates with the central electronic control unit. Monitoring, preferably of the driving speed and driving state, is described in detail in WO 00/69662 to which reference is especially made here. Tyre pressure monitoring is described in the prior art with reference to several examples.

As a result of the incoming sensor signals being linked, the logic of the control system recognises the need for a regulating process. For example, the loading state can be measured by a load sensor 23, by axle or wheel by wheel, after a short rest time every time the vehicle comes to a standstill and the last value before continuing the journey can be used as the new desired value to calculate the desired tyre pressure. For this purpose the electronic unit 1 switches the pneumatic elements as follows:

If, as a result of the respectively pre-determined switching value in the control performance graphs being exceeded, a switching command is given to increase the pressure in one or in a plurality of tyres or control circuits, the electromagnetically actuated control valves 3 are opened via the electric control leads 2. The compressed air flows via the control air lines 11 and the control air duct of the sealing package 4 to the wheel valves 5 and opens the valves for filling. At the same time, the inlet valve 6 and the filling valves 7 of the respective wheels are opened via which the compressed air from the pressure reservoir 9, supplied by the compressor 8, now flows through the air filling lines 10 and the air filling duct of the sealing package 4 via the wheel valve 5 into the respective tyres 13 to increase the tyre inner pressure.

Since the volume-of the tyres 13 is very large-compared with the internal volume of the filling lines 10 and the change in pressure in the tyre takes place relatively slowly, the tyre inner pressure can be regarded as quasi-static from the point of view of measuring technique and a sufficiently accurate value can be determined merely by measuring the static component of the air. The wheel electronic system with the relevant pressure sensor of the tyre pressure control system in the wheel interior 12 continuously determines the respective pressure value and transmits this via the electric control lead 14 to the central electronic control unit 1 which interrupts the filling process when the desired value is reached, ending the control of the control valve 3, filling valve 7 and inlet valve 6. Thus the pneumatically actuated wheel valve 5 also closes. All the compressed-air lines 10, 11 are then vented.

Since the continuous measurement and transmission of the pressure signal over the required lifetime requires more capacity than can be provided by the internal battery in the wheel electronics, the wheel electronic system 12 is buffered by a second battery 19 accommodated in the wheel rim 20 and coupled electrically to the wheel electronic system 12 via an isolated lead 21.

If, as a result of the respectively pre-determined switching value in the control performance graphs being exceeded, a switching command is given to reduce the pressure in one or in a plurality of tyres, the same process as described above is carried out except that the inlet valve 6 remains closed. Instead of this, the outlet valve 15 is opened and air flows in the reverse direction from the tyre 13 via the wheel valve 5, the filling lines 10, the filling valves 7, the outlet valve 15 and a silencer 16 into the open. A check valve 17 prevents the pressure from going below the envisaged minimum air pressure and interrupts the deflating process when said pressure is reached. The switch-off command is also given by the corresponding sensor signal of the wheel electronic system 12 to the central electronic control unit 1 when the desired pressure is reached.

The driver can be informed of the respective state of the tyres via a corresponding display 18. This information can on the one hand be a defect warning or any information on the respective vehicle maximum speed assigned to the loading and pressure state of the tyres.

FIG. 1 also shows the extension of the system by an air drier 22 which can be, but need not be, a requirement depending on the climatic conditions of use. Any freezing and thus failure of the tyre pressure regulating system can thus be prevented by removing moisture from the filling air before it is fed into the system.

FIG. 2 shows a system for control of the tyre pressure regulating system by axle. The simplification consists in the fact that for each control circuit, in the representation shown for each axle, only one control valve 3 and one filling valve 7 is required. Furthermore the lines 10, 11 can be guided simply to the wheels of a control circuit over fairly long distances. This simplification is primarily important for vehicles having more than two axles, e.g., heavy commercial vehicles with trailers since a substantial reduction in expenditure can be achieved by combining a plurality of wheels or axles.

According to FIGS. 3 and 4, the second battery 19 is accommodated in a recess of a wheel rim 24 which is constructed as a button cell in the exemplary embodiment. The battery 19 is accommodated by a casing 26 which can be closed tightly by a lid 27. The leads 21 leading to the battery terminals are accommodated insulated in a cavity 25 of the wheel rim 24. The other ends of the leads 21 are electrically connected to the battery or the accumulator 12 of the wheel electronic system.

1. A method for operating a device for monitoring and wirelessly signalling a pressure change, and for automatically regulating the pressure in pneumatic tyres on vehicles, wherein the pressure information for the electronic tyre pressure regulating system is provided by a sensor unit inside the tyre, the loading state of the vehicle is automatically determined and in the event of deviations of the actual value of the tyre pressure from the desired value depending on the weight loading, the tyre pressure is corrected to the desired value, characterized in that during the journey respectively with the engine running and with the wheels simultaneously at a standstill, the axle loads are determined in time steps and the last value of the axle load is used as the current actual value for calculating the desired value of the tyre pressure.

2. The method according to claim 1, characterized in that the pressure information is continuously transmitted during the pressure regulating process.

3. The method according to claim 1, characterized in that the wheels are controlled individually or combined in groups, e.g. per axle, as desired.
